(19) United States
(12) Patent Application Publication
(10) Pub. No.: US 2021/0180608 A1
(43) Pub. Date: Jun. 17, 2021

(54) COMPRESSOR AND COMPRESSOR CASING

(71) Applicant: BMTS Technology GmbH & Co. KG, Stuttgart (DE)

(72) Inventors: Murat Öztürk, Rottenburg (DE); Daniel Schulze, Kernen (DE); Michael Wendland, Ditzingen (DE)

(73) Assignee: BMTS Technology GmbH & Co. KG

(21) Appl. No.: 17/109,274

(22) Filed: Dec. 2, 2020

(30) Foreign Application Priority Data
Dec. 11, 2019 (EP) 19215251.0

(51) Int. Cl. F04D 29/42; F04D 29/28

(52) U.S. Cl. CPC F04D 29/4206; F02B 37/12; F04D 29/284

(57) ABSTRACT

A compressor (1) has a cast compressor casing (2) with an inlet port (3) oriented in an axial direction (AR), an intake chamber (4) with an impeller, a volute (5) and a pressure port (6) connected consecutively. The volute (5) orbits the intake chamber (4) and the pressure port (6) extends tangentially outwards from the volute (5). In the compressor casing (2), an air recirculation duct (7) has a suction-side duct (12) and pressure-side duct (13), which is connected to the inlet port (3) at a pressure connection point (13a) downstream of the impeller and downstream of a tongue formed by the volute (5) on an outer wall of the pressure connection (6) facing the volute. The suction-side duct (12) is connected to the inlet port (3) at a suction connection point (12a) upstream of the impeller.

### TECHNICAL FIELD

The invention relates to a compressor for a turbocharger of a vehicle and to a compressor casing for the compressor.

### BACKGROUND

A compressor is a part of a turbocharger, which is used in a vehicle to compress air for its engine. The compressor usually has a compressor casing in which a compressor impeller is mounted. The compressor casing usually has an inlet port, an intake chamber for the compressor impeller, a volute, and a pressure port connected to one another in terms of airflow. The air that is sucked in is led via the inlet port to the compressor impeller in the intake chamber, compressed in the compressor impeller, and further led, via the volute and the pressure port, from the compressor to the engine. In the compressor casing, an air recirculation duct may also connect the pressure-side and the suction-side in terms of airflow. An electrical air recirculation valve is then arranged in the air recirculation duct, which closes or opens the air recirculation duct. By means of the air recirculation duct, higher pressure ratios may be achieved on the surge line of the compressor for a given compressor mass flow, thus increasing the efficiency of the compressor. However, the disadvantage is that the space required for the compressor is increased by the air recirculation valve, arranged on the outside of the compressor casing, and the valve flange provided for the valve.

The compressor casing is usually cast in aluminum using the lost core process. However, the disadvantage is that relatively large wall thicknesses of the compressor casing are required to compensate for the tolerances arising from the positioning of the core with respect to the outer mold. These tolerances may be reduced if the compressor casing is manufactured using the die casting process. However, the freedom of design—and in particular the freedom of design in the manufacture of the air recirculation duct and the valve flange—is disadvantageously limited here, as undercuts in the compressor casing can only be implemented by means of sliders.

U.S. Pat. No. 6,193,463 B1 discloses a compressor casing that is manufactured by the die casting process. The compressor casing comprises a total of three separate parts, which are then assembled to form the compressor casing. Thus the flow path in the compressor casing may be very complex. From DE 10 2014 214 226 A1 another compressor casing is of known art, which is manufactured by the die-casting process. Here the compressor casing comprises a plastic part and an aluminum part, which are assembled to form the compressor casing. By this means a thermodynamically beneficial volute may be implemented in the compressor. The compressor casing also contains an air recirculation duct, consisting of two ducts that are radially oriented with the inlet port. U.S. Pat. No. 8,161,745 B2 discloses a compressor casing with an air recirculation duct consisting in total of two ducts, which are oriented at an angle to the longitudinal central axis of the inlet port. EP 2 553 275 B1 discloses a compressor casing with an air recirculation duct in the form of two ducts which are oriented parallel with respect to one another, and do not have any undercuts. This allows the two ducts to be represented by a single slider in the course of manufacture.

### SUMMARY

It is therefore desirable to specify an improved, or at least an alternative, embodiment for a compressor of the generic type and its compressor casing, in which the disadvantages described are overcome. In particular, the compressor and its compressor casing should have a compact configuration, good fluid mechanical properties, and should be able to be manufactured by the die casting process.

A compressor is proposed for a turbocharger of a vehicle. The compressor has a cast compressor casing, in which is mounted a compressor impeller for the compression of air. The compressor casing has an inlet port oriented in an axial direction, an intake chamber for the compressor impeller, a diffuser surrounding the intake chamber in a radially outward direction, a volute, and a pressure port. Here the inlet port, the intake chamber with the compressor impeller, the diffuser, the volute, and the pressure port, are sequentially connected in terms of airflow. The intake chamber is arranged axially adjacent to the inlet port, the volute circumferentially surrounds the diffuser and the intake chamber in a radially outward direction, and the pressure port is, at least in certain regions, directed tangentially outwards from the volute, preferably at least in the transition region from the volute to the pressure port. The design of the compressor casing also features an air recirculation duct, which has a suction-side duct and a pressure-side duct. The pressure-side duct is connected to the pressure connection point downstream of the compressor impeller in terms of airflow, and the suction-side duct is connected to a suction connection point upstream of the compressor impeller in terms of airflow. In accordance with the invention, the pressure connection point is formed downstream of a tongue formed by the volute on an outer wall of the pressure port, facing toward the volute. The arrangement of the pressure connection point according to an aspect of the invention enables a particularly compact design of compressor to be achieved. In addition, the length of the pressure-side duct and the suction-side duct and the flow deflection in the air recirculation duct can be reduced. By this means, the overall flow guidance in the air recirculation duct is improved.

Inside the compressor, the diffuser circumferentially surrounds the intake chamber in an outward direction, and thereby circumferentially surrounds an outlet of the compressor impeller. In other words, the diffuser is arranged radially outwards of the intake chamber. The volute circumferentially surrounds the diffuser in a radially outward direction, and the diffuser is connected to the volute in terms of airflow. In other words, the diffuser lies radially between the intake chamber with the compressor impeller and the volute. By virtue of the diffuser, the dynamic pressure generated by the compressor impeller is converted into static pressure. The volute wraps around the diffuser in a circumferential direction over 360°, wherein the tongue separates the beginning and end of the volute from one another at 0° and 360° respectively. In the inventive compressor, the air to be compressed flows axially into the intake chamber and onward to the compressor impeller in the intake chamber. The air is compressed by the compressor impeller and flows onward via the diffuser and the volute into the pressure port. From the pressure port compressed air is led to the engine of the vehicle. The suction side of the compressor is arranged upstream of the compressor impeller, and the pressure side of the compressor is arranged downstream of the compressor impeller, in the compressor casing. The suction-side duct and the pressure-side duct are inclined with respect to the axial direction, that is to say, arranged at an angle not equal to 0°. To enable a more compact design of the compressor, the suction-side and pressure-side ducts may be arranged axially offset with respect to one another. In other words, the suction-side duct and the pressure-side duct may lie in planes parallel with respect to one another, which are arranged inclined with respect to the axial direction, that is to say, at an angle not equal to 0°. The suction-side duct is then oriented at a suction-side angle less than or equal to 90° with respect to the inlet port. The suction-side duct and the pressure-side duct are preferably arranged transversely to the axial direction. In other words, the two ducts, that is to say, their longitudinal central axes, are in each case in a plane arranged transversely to the axial direction. The suction-side duct is then oriented at a suction-side angle equal to 90° with respect to the axial direction. Here and in what follows the terms “axial” and “radial” always relate to the axial direction.

A valve flange may advantageously be formed on the compressor casing in the region of the air recirculation duct. The compressor may also have an air recirculation valve, the mounting flange of which is attached to the valve flange. The air recirculation valve then engages with the air recirculation duct in certain regions, and may either connect the suction-side duct and the pressure-side duct with one another in terms of airflow, or separate them from one another in an airtight manner. The air recirculation valve is preferably electrical. The compressor casing may advantageously be cast in one piece with the suction-side duct and the pressure-side duct in a die-casting process. The compressor casing is preferably cast in aluminum. Alternatively, the compressor casing may be cast in one piece with either the suction-side duct, or the pressure-side duct, in a die-casting process. The compressor casing is preferably cast in aluminum. The pressure-side duct that is now not cast with the compressor casing, or the suction-side duct that is now not cast with the compressor casing, can then be mechanically incorporated into the cast compressor casing. The mechanical incorporation is preferably carried out by means of drilling or milling.

The pressure-side duct and the suction-side duct may advantageously be oriented with respect to one another at a duct angle greater than 0° and less than or equal to 90°. Here the duct angle is preferably between 30° and 90°, more preferably between 30° and 60°. The pressure-side duct and the suction-side duct preferably converge toward an air recirculation valve, which is explained in more detail below. From a fluid mechanics point of view, the duct angle should lie as close as possible to 90° so as to reduce the deflection of the flow from the pressure-side duct into the suction-side duct. In terms of flow this results in an optimum range between 30° and 90°. From a manufacturing point of view, however, the duct angle should be selected such that the pressure-side duct and the suction-side duct can be removed from the mold, or the pressure-side duct may be manufactured by subsequent mechanical processing. From a manufacturing point of view this results in an optimum range between 0° and 60°. If the pressure-side duct and the suction-side duct are oriented at the duct angle with respect to one another, the longitudinal central axes of the two ducts are not oriented parallel with respect to one another. The longitudinal central axes of the two ducts may intersect, or may be skewed with respect to one another. By this means the airflow does not need to be deflected so much in the transition between the pressure-side duct and the suction-side duct.

The pressure-side duct and the pressure port may advantageously be oriented at a pressure-side angle greater than 0°, and less than or equal to 90°, with respect to one another. Here the pressure-side angle preferably lies between 30° and 90°, more preferably between 30° and 60°. From a fluid mechanics point of view, the pressure-side angle should be as close to 0° as possible so as to reduce the deflection of the flow from the pressure port into the pressure-side duct. This results in an optimum range between 0° and 60° in terms of flow. However, from a manufacturing point of view, the pressure-side angle should be selected so that the pressure-side duct can be removed from the mold or manufactured by subsequent mechanical processing. This results in an optimum range between 30° and 90° from a manufacturing point of view. If the pressure port and the pressure-side duct are oriented at the pressure-side angle with respect to one another, the longitudinal central axis of the pressure-side duct and the longitudinal central axis of the pressure port are not oriented parallel with respect to one another. The longitudinal central axis of the pressure-side duct and the longitudinal central axis of the pressure port may therefore intersect or be skewed with respect to one another. With this arrangement of the pressure-side duct, the air flow needs to be deflected less in the transition between the pressure port and the pressure-side duct. In a particularly advantageous embodiment of the compressor, the two longitudinal central axes intersect, so that the pressure-side duct branches off axially centrally from the pressure port, that is to say, opens axially centrally into the pressure port. With a closed air recirculation duct, negative effects of the pressure-side duct on the flow in the pressure port can advantageously be reduced with this form of embodiment.

The suction-side duct and the pressure port may be oriented parallel with respect to one another, whereby the pressure-side angle and the duct angle are equal. In other words, the longitudinal central axis of the suction-side duct and the longitudinal central axis of the pressure port may be oriented parallel with respect to one another. With this advantageous form of embodiment, the slider for the pressure port and the slider for the suction-side duct can enter into the mold from the same direction in the course of the manufacture of the compressor casing. If the valve flange for the air recirculation valve formed on the compressor casing is adapted accordingly, the two sliders may be embodied as one slider. By these means, the costs of the molding tools can be reduced. Alternatively, the suction-side duct and the pressure port may not be oriented parallel with respect to one another, whereby the pressure-side angle and the duct angle differ from one another. With this embodiment the compressor can be configured to be more compact.

The suction-side duct may open radially into the inlet port. The longitudinal central axis of the suction-side duct and the longitudinal central axis of the inlet port then intersect, and are oriented perpendicular to one another. A suction-side angle between the inlet port and the suction-side duct is then equal to 90°. The suction connection point of the suction-side duct may advantageously be arranged such that the flow in the inlet port experiences a pre-swirl. The pre-swirl leads to an improved flow to the compressor impeller near the surge line of the compressor by avoiding separations in the region of the compressor impeller blades. By this means the surge line performance of the compressor is further improved.

Advantageously, the sum of all the deflection angles to be encountered by the air flowing through the air recirculation duct may be less than or equal to 360°. When air flows through the air recirculation duct, the air from the pressure port into the pressure-side duct is first deflected through the pressure-side angle as defined above. A first deflection angle in the air recirculation duct thus corresponds to the pressure-side angle. The air from the pressure-side duct is then deflected into the suction-side duct. The two ducts have the above-defined duct angle with respect to one another, and the air is deflected through a second deflection angle. Here the second deflection angle corresponds to a difference between 180° and the above-defined duct angle. The air flows from the suction-side duct into the inlet port and is deflected through the above-defined suction-side angle. A third deflection angle is therefore equal to the suction-side angle. The sum of these three deflection angles is therefore less than or equal to 360°. Alternatively formulated, the sum of a pressure-side angle between the pressure port and the pressure-side duct, a duct angle between the suction-side duct and the pressure-side duct, and a suction-side angle between the suction-side duct and the inlet port, may be less than or equal to 180°.

In what follows, some examples are given, purely as examples, for purposes of illustration. If the pressure-side angle is close to 90°, the duct angle is 35°, and the suction-side angle is 90°, the sum of all the deflection angles is about 325°. If the pressure-side angle is 45°, the duct angle is 35°, and the suction-side angle is 90°, the sum of all the deflection angles is 280°. If the pressure-side angle is 45°, the duct angle is 45°, and the suction-side angle is 90°, the sum of all the deflection angles is 270°.

A cross-section of the pressure port downstream of the pressure connection point may advantageously be larger than a cross-section of the pressure port upstream of the pressure connection point. When the air recirculation duct is closed, negative effects of the pressure-side duct on the flow in the pressure port are advantageously reduced in this way. In addition, the cross-section on a wall part of the pressure port, which extends outwards from the pressure connection point parallel with respect to the longitudinal central axis of the pressure port, may increase more progressively.

A valve flange can advantageously be formed on the compressor casing in the region of the air recirculation duct. Provision can also advantageously be made for the valve flange not to be tangentially oriented with respect to a radially outer wall part of the volute. When viewed in the axial direction, the valve flange, or more particularly, a flange plane spanned by the latter, intersects the radially outer wall part of the volute. Alternatively or additionally, the valve flange and the pressure port can be oriented with respect to one another at an angle greater than 0° and less than or equal to 90°. In other words, the longitudinal central axis of the pressure-side duct and the valve flange, or more particularly, a flange plane spanned by the latter, intersect at an angle greater than 0° and less than or equal to 90°. In this advantageous manner the compressor can be configured so as to be more compact. In particular, the air recirculation valve arranged on the valve flange can be positioned non-radially with respect to the volute and to the inlet port, so that the compressor is configured so as to be more compact overall. In this context the term “non-radially” means that the longitudinal central axis of the air recirculation valve and the longitudinal central axis of the inlet port do not intersect.

The valve flange may advantageously be oriented at right angles to the pressure-side duct and inclined with respect to the suction-side duct. In other words, the valve flange lies in a flange plane, which is oriented at right angles to the longitudinal central axis of the pressure-side duct, and its normal, at the duct angle defined above, is aligned with the longitudinal central axis of the suction-side duct. If the suction-side duct and the pressure-side duct are oriented transversely to the axial direction, the valve flange and its flange plane are then arranged parallel with respect to the axial direction.

The pressure-side duct may advantageously branch off axially centrally from the pressure port to open axially centrally into the pressure port. In other words, the longitudinal central axis of the pressure port and the longitudinal central axis of the pressure-side duct intersect. The angle of intersection between the two longitudinal central axes then corresponds to the pressure-side angle as defined above. When the air recirculation duct is closed, negative effects of the pressure-side duct on the flow in the pressure port can advantageously be reduced with this form of embodiment. Alternatively, the pressure-side duct may not branch off axially centrally from the pressure port, that is to say, open axially centrally into the pressure port. In other words, the longitudinal central axis of the pressure port and the longitudinal central axis of the pressure-side duct may not intersect. The two longitudinal central axes are then skewed with respect to one another. When projected onto one another, the longitudinal central axes then have the above-defined pressure-side angle with respect to one another. The pressure connection point in the pressure port is thus designed so as to be axially offset with respect to its longitudinal central axis, and the pressure-side duct lies on the volute in certain regions. This allows for a more compact compressor design.

In a particularly advantageous embodiment of the compressor, the pressure-side duct opens axially centrally into the pressure port. When the air recirculation duct is closed, negative effects of the pressure-side duct on the flow in the pressure port can advantageously be reduced with this form of embodiment. Furthermore, in this embodiment provision is made for the suction-side duct and the pressure port to be oriented parallel with respect to one another. This allows the slider for the pressure port and the slider for the suction-side duct to enter the mold from the same direction in the course of the manufacture of the compressor casing. If the valve flange for the air recirculation valve formed on the compressor casing is adapted accordingly, the two sliders can be designed as one slider. In this way, the costs of the mold can be reduced. In addition, in this embodiment provision is made for the suction-side duct to open radially into the inlet port.

In an alternative embodiment of the compressor the pressure-side duct does not open axially centrally into the pressure port. In other words, the longitudinal central axis of the pressure port and the longitudinal central axis of the pressure-side duct do not intersect. The two longitudinal central axes are then skewed with respect to one another. When projected onto one another, the longitudinal central axes then have the above-defined pressure-side angle with respect to one another. The pressure connection point in the pressure port is thus designed so as to be axially offset with respect to its longitudinal central axis, and the pressure-side duct lies on the volute in certain regions. The pressure-side duct remains separated in an airtight manner from the volute in this region. The pressure-side duct lies appropriately on the volute facing toward the inlet port. In this form of embodiment, the length of the suction-side duct and the length of the pressure-side duct can be reduced, which has a positive effect on the flow in the open air recirculation duct.

In another alternative embodiment of the compressor, the pressure-side duct does not open axially centrally into the pressure port. The pressure connection point is arranged in the pressure port so as to be axially offset with respect to its longitudinal central axis, and the pressure-side duct lies on the volute in certain regions. In addition, the suction-side duct and the pressure port are not oriented parallel with respect to one another. This means that the above-defined pressure-side angle and the above-defined duct angle are not the same. In this further form of embodiment, the length of the suction-side duct and the length of the pressure-side duct can be reduced, which has a positive effect on the flow in the open air recirculation duct.

The embodiments described here all have certain advantages. Accordingly, from the embodiments described, there is always one embodiment that may be selected, which offers the desired advantages with regard to the flow through the pressure port, or the flow through the pressure-side duct, or the manufacture of the compressor casing. The described embodiments are exemplary, and embodiments that deviate from them are also conceivable.

The invention also relates to a compressor casing for the above-described compressor. In order to avoid repetition, reference is made to the above statements at this point.

Further important features and advantages of the invention become evident from the drawings, and from the corresponding detailed description of the drawings.

The features mentioned above and those to be explained below may be used not only in the combination specified in each case, but also in other combinations, or on their own, without thereby leaving the scope of the present invention.

Preferred examples of the invention are shown in the drawings and are explained in more detail in the following description, wherein identical reference symbols refer to identical, or similar, or functionally identical, components.

### BRIEF DESCRIPTION OF THE DRAWINGS

In the drawings,

FIG. 1 shows an exploded view of a compressor according to an aspect of the invention with an air recirculation valve;

FIG. 2 shows a view of an inventive compressor casing with a cut-out in the region of an air recirculation duct;

FIG. 3 shows a cross-sectional view of the inventive compressor casing in the region of the air recirculation duct;

FIG. 4 shows a view of the flow ducts of the inventive compressor casing in a first form of embodiment;

FIG. 5 shows a view of the flow ducts of the inventive compressor casing in a second form of embodiment; and

FIG. 6 shows a view of the flow ducts of the inventive compressor casing in a third form of embodiment.

### DETAILED DESRIPTION OF THE DRAWINGS

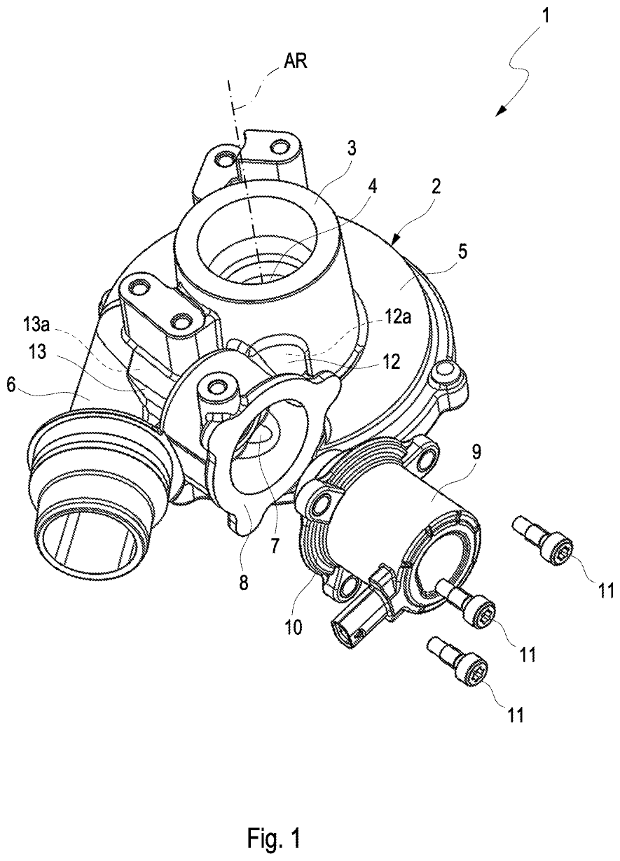

FIG. 1 shows an exploded view of a compressor 1 for a turbocharger of a vehicle. The compressor 1 has a compressor casing 2 according to an aspect of the invention. Here the compressor casing 2 is cast in one piece from aluminum in a die-casting process. The compressor casing 2 here comprises an inlet port 3, an intake chamber 4, a diffuser (not visible here), a volute 5, and a pressure port 6. The inlet port 3, the intake chamber 4, the diffuser, the volute 5 and the pressure port 6 are connected sequentially in terms of airflow. The inlet port 3 is oriented in an axial direction AR, such that its longitudinal central axis L3 and the axial direction AR are parallel. The intake chamber 4 is arranged downstream of the inlet port 3 and axially adjacent to the latter. A compressor impeller—not visible here—is mounted in the intake chamber 4. The diffuser circumferentially surrounds the intake chamber 4 in a radially outward direction, and is arranged downstream of the intake chamber 4. The volute 5 is arranged downstream of the diffuser and the intake chamber 4, and circumferentially surrounds both of these in a radially outward direction. The pressure port 6 is arranged downstream of the volute 5 and is directed tangentially outwards from the volute.

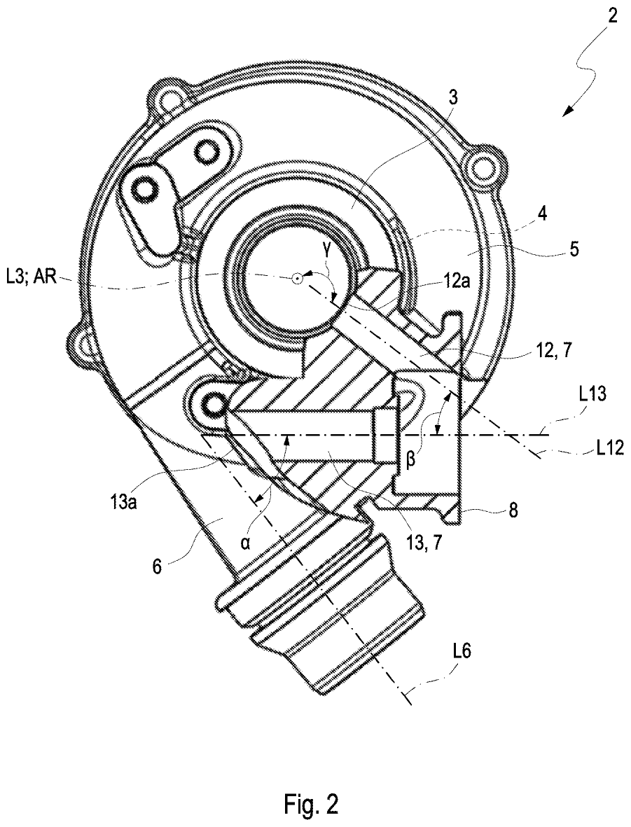

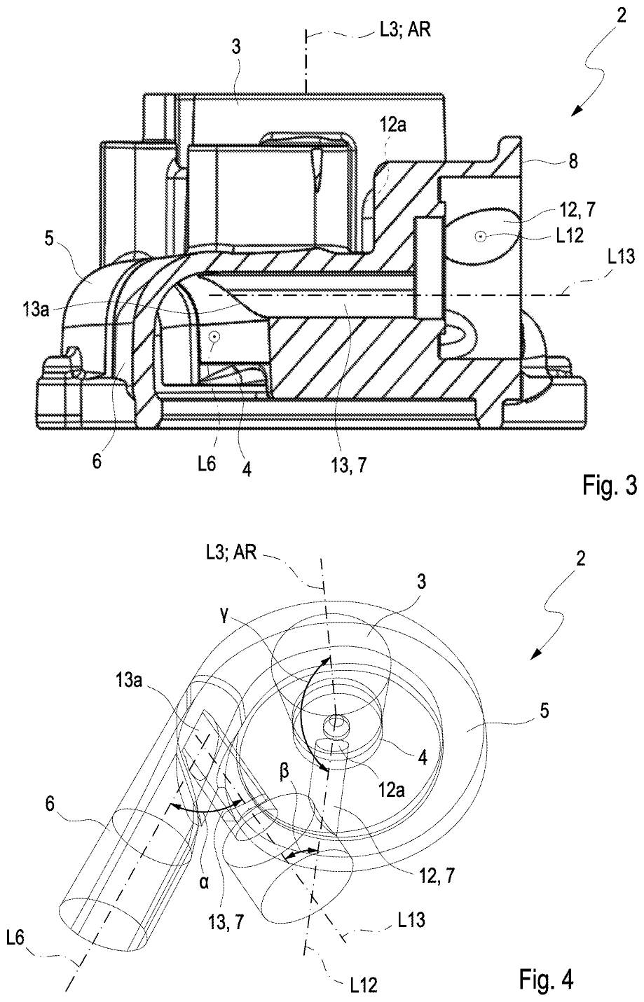

In the compressor casing 2 is formed an air recirculation duct 7, which connects the inlet port 3 and the pressure port 6 in terms of airflow. In the region of the air recirculation duct 7 is formed a valve flange 8, to which an air recirculation valve 9 with its mounting flange 10 is then attached by means of screws 11. Here the valve flange 8, or more particularly, its flange plane, is not oriented tangentially to a radially outer wall part of the volute 5. In other words, in an axial projection the valve flange 8, that is to say, its flange plane, and the radially outer wall part of the volute 5 intersect one another. The air recirculation valve 9 attached to the valve flange 8 is therefore not radially aligned with the volute 5 and the inlet port 3, as a result of which the compressor 1 is more compactly configured overall. The air recirculation valve 9 separates the air recirculation duct 7 into a suction-side duct 12 and a pressure-side duct 13. The air recirculation valve 9 can separate the two ducts 12 and 13 from one another in an airtight manner, or connect them in terms of airflow, thereby closing or opening the air recirculation duct 7. The pressure-side duct 13 is connected in terms of airflow to the pressure port 6 at a pressure connection point 13a in the transition region between the volute 5 and the pressure port 6. The suction-side duct 12 is then connected in terms of airflow to the inlet port 3 at a suction connection point 12a. The two ducts 12 and 13 are arranged axially offset with respect to one another, and in each case are oriented transversely to the axial direction AR, that is to say, they lie in a plane oriented transversely to the axial direction AR. The construction of the compressor casing 2 is explained in more detail in what follows with the aid of FIG. 2 and FIG. 3.

FIG. 2 shows a view of the compressor casing 2 for the inventive compressor 1 shown in FIG. 1, with a cut-out in the region of the air recirculation duct 7. FIG. 3 shows a cross-sectional view of the inventive compressor casing 2 in the region of the air recirculation duct 7. Here the pressure-side duct 13 and the pressure port 6 are oriented with respect to one another at a pressure-side angle α which lies between 0° and 90°. In this case the pressure-side angle α is about 45°. The longitudinal central axis L13 of the pressure-side duct 13 and the longitudinal central axis L6 of the pressure port 6 are therefore not oriented parallel with respect to one another. As can be seen in particular in FIG. 3, the longitudinal central axes L6 and L13 are skewed with respect to one another. When projected onto one another, the longitudinal central axes L6 and L13 intersect at the pressure-side angle α. This means that the pressure-side duct 13 does not connect centrally into the pressure port 6, and the pressure connection point 13a and the longitudinal central axis L6 of the pressure port 6 are axially offset with respect to one another. The pressure-side duct 13 can thereby be partially arranged on the volute 5, and the lengths of the ducts 12 and 13 can be reduced. By this means the compressor casing 2 is therefore built to be more compact.

Furthermore, the pressure-side duct 13 and the suction-side duct 12 are oriented with respect to one another at a duct angle β which lies between 0° and 90°. Here, the duct angle β is about 40°. The longitudinal central axes L12 and L13 of the two ducts 12 and 13 are not oriented parallel with respect to one another. As can be seen in particular in FIG. 3, the two ducts 12 and 13 are axially offset with respect to one another, so that the longitudinal central axes L12 and L13 are skewed with respect to one another. When projected onto one another, they intersect at the duct angle β. The suction-side duct 12 and the pressure port 6 are also not oriented parallel with respect to one another, and have an angle of less than 180° with respect to one another. This means that the pressure-side angle α and the duct angle β are also not equal to one another. Furthermore, the suction-side duct 12 is oriented with respect to the inlet port 3 at a suction-side angle γ equal to 90°. Furthermore, the suction-side duct 12 is radially connected to the inlet port 3. In other words, the longitudinal central axis L12 of the suction-side duct 12 and the longitudinal central axis L3 of the inlet port 3 intersect at a suction-side angle γ equal to 90°. The sum of the pressure-side angle α, the duct angle β, and the suction-side angle γ, is less than 180°. The deflection angles in the air recirculation duct 7 are defined by the pressure-side angle α, the difference between 180° and the duct angle β, and the suction-side angle γ. The sum of all these deflection angles is therefore less than 360°.

As can be seen in particular in FIG. 2, the valve flange 8, or more particularly, its flange plane, is aligned parallel with respect to the axial direction AR, and at right angles to the pressure-side duct 13, that is to say, to its longitudinal central axis L13. Furthermore, a normal to the valve flange 8, or to its flange plane, has the duct angle β with respect to the suction-side duct 12. Furthermore, it can be seen in FIG. 2 that a cross-section of the pressure port 6 downstream of the pressure connection point 13a is larger than a cross-section of the pressure port 6 upstream of the pressure connection point 13a. When the air recirculation duct 7 is closed, any negative effects of the pressure-side duct 13 on the flow in the pressure port 6 can in this way be reduced.

FIG. 4 shows a view of the flow ducts of the inventive compressor casing 2 in a first form of embodiment. This embodiment corresponds to the compressor casing 2 that is shown in FIG. 1 to FIG. 3. In the first form of embodiment, the pressure-side duct 13 is not centrally connected to the pressure port 6, so that the pressure connection point 13a in the pressure port 6 is axially offset with respect to the latter's longitudinal central axis L6. As a result, the pressure-side duct 13 is designed so as to be axially offset toward the inlet port 6 and lies in certain regions on the volute 5. In this form of embodiment, the lengths of the ducts 12 and 13 can be reduced, which has a positive effect on the flow in the open air recirculation duct 7. In addition, the pressure port 6 and the suction-side duct 12 are not arranged parallel with respect to one another.

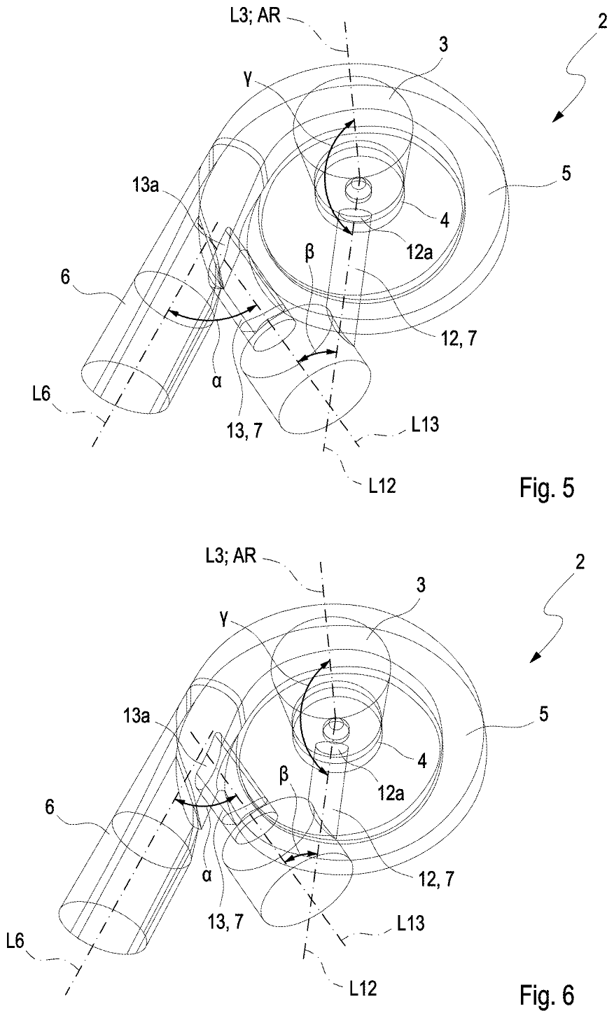

FIG. 5 shows a view of the flow ducts of the inventive compressor casing 2 in a second form of embodiment. In the second form of embodiment, in contrast to the first form of embodiment, the pressure-side duct 13 is arranged displaced in a radially outward direction and axially offset toward the volute 5. The pressure-side duct 13 thereby connects axially centrally into the pressure port 6. In other words, the longitudinal central axis L6 of the pressure port 6 and the longitudinal central axis L13 of the pressure-side duct 13 do intersect in this case. However, the length of the suction-side duct 12 is increased here, compared to the first form of embodiment. When the air recirculation duct 7 is closed, the negative effects of the pressure-side duct 13 on the flow in the pressure port 6 can advantageously be reduced in the second form of embodiment. In other respects the compressor casing 2 in the second embodiment corresponds to the compressor casing 2 in the first form of embodiment.

FIG. 6 shows a view of the flow ducts of the compressor casing 2 in a third form of embodiment. Here the pressure-side duct 13 does not connect centrally into the pressure port 6, with the result that the pressure connection point 13a is axially offset in the pressure port 6. By this means, the pressure-side duct 13 is designed so as to be axially offset toward the inlet port 6 and lies in certain regions on the volute 5. In addition, the suction-side duct 12 and the pressure port 6 are not here oriented parallel with respect to one another. Here the pressure-side angle α is greater than in the first form of embodiment, so that the length of the suction-side duct 12 is reduced. In other words, the suction-side duct 12 is displaced toward the inlet port 3, and the pressure-side duct 13 is rotated around the pressure connection point 13a by about 5° toward the inlet port 3. In the third form of embodiment, the length of the ducts 12 and 13 can be further reduced in comparison to the first embodiment in FIG. 4; this has a positive effect on the flow in the open air recirculation duct 7.

What is claimed is:

1. A compressor (1) for a turbocharger of a vehicle, comprising:
a cast compressor casing (2), in which a compressor impeller for compressing air is mounted, the compressor casing (2) having:
an inlet port (3) oriented in an axial direction (AR),
an intake chamber (4) with the mounted compressor impeller,
a diffuser surrounding the intake chamber (4) in a radially outward direction, a volute (5), and
a pressure port (6), which are connected sequentially in terms of airflow,
wherein the intake chamber (4) is arranged axially adjacent to the inlet port (3), the volute (5) circumferentially surrounds the diffuser and the intake chamber (4) in a radially outward direction, and the pressure port (6) is directed, at least in part, tangentially outwards from the volute (5),
wherein the compressor casing (2) forms an air recirculation duct (7), which has a suction-side duct (12) and a pressure-side duct (13),
wherein the pressure-side duct (13) is connected to a pressure connection point (13a) downstream of the compressor impeller in terms of airflow, and the suction-side duct (12) is connected to the inlet port (3) at a suction connection point (12a) upstream of the compressor impeller in terms of airflow,
wherein the pressure connection point (13a) is downstream of a tongue, formed by the volute (5), on an outer wall of the pressure port (6) facing toward the volute (5).

2. The compressor according to claim 1, wherein the suction-side duct (12) and the pressure-side duct (13) are oriented with respect to one another at a duct angle (β) greater than 0° and less than or equal to 90°, preferably between 30° and 90°, more preferably between 30° and 60°, and preferably converging toward an air recirculation valve (9).

3. The compressor according to claim 1, wherein the pressure-side duct (13) and the pressure port (6) are oriented with respect to one another to enclose a pressure-side angle (α) greater than 0° and less than or equal to 90°.

4. The compressor according to claim 3, wherein the pressure-side angle (α) is between 30° and 90°.

5. The compressor according to claim 4, wherein the pressure-side angle (α) is between 30° and 60°.

6. The compressor according to claim 3, wherein the suction-side duct (12) and the pressure port (6) are oriented parallel with respect to one another, and as a result the pressure-side angle (α) and the duct angle (β) are of equal size.

7. The compressor according to claim 3, wherein the suction-side duct (12) and the pressure port (6) are oriented non-parallel with respect to one another, and as a result the pressure-side angle (α) and the duct angle (β) differ from one another.

8. The compressor according to claim 1, wherein the air recirculation duct (7) defines air deflection angles to be passed through by air flowing in the air recirculation duct (7) and the sum of all deflection angles within the air recirculation duct (7) is less than or equal to 360°.

9. The compressor according to claim 1, wherein the sum of
a pressure-side angle (α) between the pressure port (6) and the pressure-side duct (13),
a duct angle (β) between the suction-side duct (12) and the pressure-side duct (13), and
a suction-side angle (γ) between the suction-side duct (12) and the inlet port (3)
is less than or equal to 180°.

10. The compressor according to claim 1, wherein the suction-side duct (12) opens radially into the inlet port (3).

11. The compressor according to claim 1, wherein the pressure-side duct (13) branches off axially centrally from the pressure port (6).

12. The compressor according to claim 1, wherein the pressure-side duct (13) does not branch off axially centrally from the pressure port (6), with the result that the pressure connection point (13a) in the pressure connection (6) is formed axially offset with respect to the longitudinal central axis (L6) of the pressure port (6), and the pressure-side duct (13) lies on the volute (5) in certain regions.

13. The compressor according to claim 1, wherein a cross-section of the pressure port (6) downstream of the pressure connection point (13a) is larger than a cross-section of the pressure port (6) upstream of the pressure connection point (13a).

14. The compressor according to claim 1, wherein a valve flange (8) is formed on the compressor casing (2) in the region of the air recirculation duct (7) and is configured for attaching an air recirculation valve (9) can be fixed,
wherein the valve flange (8) is oriented non-tangentially to a wall part of the volute (5) located radially outward.

15. The compressor according to claim 14, wherein the valve flange (8) is arranged at an angle greater than 0°, and less than or equal to 90° relative to the pressure port (6).

16. The compressor according to claim 14, wherein the valve flange (8) is oriented at right angles to the pressure-side duct (13) and a normal of the valve flange (8) is oriented at a duct angle (β) with respect to the suction-side duct (12).

17. The compressor according to claim 14, further comprising an air recirculation valve (9) attached to the valve flange (8) with a mounting flange (10), wherein the air recirculation valve (9) extends into the air recirculation duct (7), and divides the air recirculation duct (7) into the suction-side duct (12) and the pressure-side duct (13).

18. The compressor according to claim 1, wherein the compressor casing (2) is cast in one piece in at least one of the following combinations in a die-casting process:
with the suction-side duct (12), wherein the pressure-side duct (13) is subsequently mechanically machined into the cast compressor casing (2);
with the pressure-side duct (13), wherein suction-side duct (12) is subsequently mechanically machined into the cast compressor casing (2);
with both the suction-side duct (12) and the pressure-side duct (13).

19. A compressor casing (2) configured for housing a compressor impeller for compressing air is mounted, the compressor casing (2) comprising:
an inlet port (3) oriented in an axial direction (AR),
an intake chamber (4) configured for accommodating the compressor impeller,
a diffuser surrounding the intake chamber (4) in a radially outward direction, a volute (5), and
a pressure port (6), which are connected sequentially in terms of airflow,
wherein the intake chamber (4) is arranged axially adjacent to the inlet port (3), the volute (5) circumferentially surrounds the diffuser and the intake chamber (4) in a radially outward direction, and the pressure port (6) is directed, at least in part, tangentially outwards from the volute (5),
wherein the compressor casing (2) forms an air recirculation duct (7), which has a suction-side duct (12) and a pressure-side duct (13),
wherein the pressure-side duct (13) is connected to a pressure connection point (13a) downstream of the compressor impeller in terms of airflow, and the suction-side duct (12) is connected to the inlet port (3) at a suction connection point (12a) upstream of the compressor impeller in terms of airflow,
wherein the pressure connection point (13a) is formed downstream of a tongue, formed by the volute (5), on an outer wall of the pressure port (6) facing toward the volute (5),
wherein the compressor casing is a cast compressor casing.
